(19) United States
(12) Patent Application Publication
(10) Pub. No.: US 2004/0246880 A1
(43) Pub. Date: Dec. 9, 2004

(54) Disk apparatus

(75) Inventor: Tetsuya Tamura, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 10/850,367

(22) Filed: May 21, 2004

(30) Foreign Application Priority Data
May 22, 2003 (JP) P 2003-144307

(51) Int. Cl. G11B 17/30

(52) U.S. Cl. 369/218

(57) ABSTRACT

The disk apparatus includes a clamp mechanism having a first adsorbent and a second adsorbent that suck each other due to a magnetic force. When a lift of a cam mechanism makes a lowering operation, the second adsorbent is pulled down and separated away from the first adsorbent. An upper inclined face and a lower inclined face of a cam body have different slopes. A cam projection provided on the lift is disposed between two inclined faces. When the cam projection is lowered to an intermediate position on the upper inclined face, the second adsorbent descends to a position where a suction force between the first and second adsorbents disappears.

### BACKGROUND OF THE INVENTION

1. Field of the Invention

The present invention relates to a disk apparatus, and more particularly to a disk apparatus including a clamp mechanism for clamping a disk, having a first adsorbent and a second adsorbent that is a partner of the first adsorbent to suck each other due to a magnetic force, and a cam mechanism with a motor as a drive source for controlling the operation of the second adsorbent to move toward or away from the first adsorbent.

2. Description of the Related Art

Referring to FIG. 3, a basic constitution of the disk apparatus will be described below. Reference numeral 1 denotes a housing having the shape of a box, and reference numeral 2 denotes a cam mechanism with a motor, not shown, as a drive source. The cam mechanism 2 includes a cam body 21 attached slidably in the transverse direction on the housing 1 and a lift 26 vertically moved following a traverse motion of the cam body 21. The lift 26 has a mount portion 28 extending transversely and provided in the lift 26, which is supported on the housing 1 to be liftable vertically, thereby guiding the vertical lifting motion. Reference numeral 4 denotes a frame that is a chassis. The frame 4 has two left and right positions at one end portion in the fore and aft direction which are attached to two left and right positions at the rear end portion of the housing 1 via the rubber dampers 51, 51, while two left and right positions at the free end portion 42 formed by the other end portion in the fore and aft direction are attached to two left and right positions of the mount portion 28 in the lift 26 via the rubber dampers 52, 52.

Reference numeral 6 denotes a clamp mechanism. This clamp mechanism 6 includes a first adsorbent 61 having a magnet and a second adsorbent 65 that is a partner of the first adsorbent. The first adsorbent 61 is rotatably fitted loosely into a bore portion 63 of a support frame 62 fixed to the housing 1. On the contrary, the second adsorbent 65 is formed as a turn table 66 fixed to a rotation shaft of a motor M installed on the frame 4, and disposed near the free end portion of the frame 4.

In the disk apparatus with this basic constitution, if a disk D is carried in by a disk tray 7, the cam body 21 is moved transversely in one direction by the rotation of a pinion 31 meshed with a rack 32 provided in the cam body 21, and the lift 26 is moved up vertically due to a traverse motion of the cam body to lift the free end portion 42 of the frame 4, so that the frame 4 is oscillated upwards around the installed position of the dampers 41, 41 at one end portion in the fore and aft direction as the fulcrum. Through a series of operations in this time, the first adsorbent 61 and the second adsorbent 65 are sucked by each other due to a magnetic force of the magnet equipped in the first adsorbent 61 to clamp the disk D in a state where it floats up from the disk tray 7, as indicated by the solid line in FIG. 3. This state is the clamp state. Thereafter, if the motor M is started, the turn table 66 shared as the second adsorbent 65 is rotated with the disk D clamped in cooperation with the first adsorbent 61, and an optical pickup, not shown, scans the recorded face of the disk being rotated in this way to perform the recording or reproduction.

On the other hand, when the clamp state is released, the pinion 32 is reversely rotated to cause a traverse motion of the cam body 21 in the reverse direction and lower the lift 26 with its traverse motion. Thereby, the free end portion 42 of the frame 4 following a down motion of the lift 26 is oscillated downwards around the installed position of the dampers 41, 41 at one end in the fore and aft direction as the fulcrum, so that the second adsorbent 65 (turn table 66) sucked to the first adsorbent 61 is left away from the first adsorbent 61, as indicated by the imaginary line in FIG. 3, and in transit, the disk D is passed onto the disk tray 7. This is a clamp releasing operation.

In the disk apparatus as described above, conventionally, the cam mechanism 2 has a constitution as shown in FIG. 4. That is, the cam body 21 is provided with a cam groove 22, and the lift 26 is provided with a cam projection 27 slidably fitted into the cam groove 22, so that the cam projection 27 is guided vertically by a groove wall face of the cam groove 22, as shown in FIG. 4. More specifically, an upper inclined face 22a and a lower inclined face 22b that are opposed in the vertical direction and inclined at the same slope in the same direction are formed by an upper groove wall face and a lower groove wall face opposed in the vertical direction of the cam groove 22, and in the clamp operation, the lower inclined face 22b pushes up the cam projection 27 by a traverse motion of the cam body 21 in one direction. On the contrary, at the early time of clamp releasing operation, when a suction force between the first adsorbent 61 and the second adsorbent 62 is exerted, the upper inclined face 22a pushed down the cam projection 27 to gradually separate the second adsorbent 65 from the first adsorbent 61 with a traverse motion of the cam body 21 in the other direction, so that the opening of the first adsorbent 61 from the second adsorbent 65 is increased due to this separation operation, and the second adsorbent 61 descends with the cam projection 27 placed on the lower inclined face 22b, after the suction force is not exerted, as shown in FIG. 3.

By the way, in the disk apparatus employing the motor as the drive source of the cam mechanism 2, the magnitude of load applied on the motor during the clamp releasing operation, and the length of time from the start time of clamp releasing operation to the end time depend on the slope (inclination) of the upper inclined face 22a in the cam groove 22. If the slope of the upper inclined face 22a is greater, the load is increased, but the time is shortened. Conversely, if the slope of the upper inclined face 22a is smaller, the load is decreased, but the time is increased. Also, if the load of motor is suppressed, the safety factor of the motor output is improved. Moreover, there is the disk apparatus in which the motor as the drive source of the cam mechanism 21 is shared as a feed operation motor for the optical pickup. In this disk apparatus, if the time required for the clamp operation or the clamp releasing operation is shortened, the temporal margin for switching the motor operation between the feed operation of the optical pickup and the clamp operation or clamp releasing operation is increased, thereby reducing the risk that the clamp releasing operation is performed while the disk is being rotated due to runaway of the feed operation, or the disk tray starts to be moved before completion of the clamp operation.

Therefore, in the disk apparatus in which the motor as the drive source of the cam mechanism 2 is shared as the feed operation motor of the optical pickup, it is desired to increase the safety factor of the motor output and the temporal margin for switching the motor operation between the feed operation of the optical pickup and the clamp operation or clamp releasing operation. However, in the conventional disk apparatus, because of the items of antinomy, the upper inclined face 22a and the lower inclined face 22b of the cam groove 22 were constructed at the same slope, and the inclination was appropriately decided in consideration of the safety factor of the motor and the temporal margin, as shown in FIG. 4. Hence, there was a problem that the safety factor of the motor was not enhanced, or the temporal margin was not secured sufficiently.

On the contrary, conventionally, a technique for constructing the thin apparatus by shortening the vertical length of the cam groove (guide groove) of the cam mechanism employed for the disk drive unit was offered in which the shape of the cam projection fitted into the cam groove is changed from column to plate, thereby shortening the length of a vertical motion range of the cam projection, and the vertical length of the cam groove (refer to JP-UM-A-4-90048). However, with this conventional technique, it is difficult to fully secure the safety factor of the motor and the temporal margin in the clamp releasing operation, because the upper inclined face of the cam groove is straight inclined face over its entire length in the same way as shown in FIG. 4.

### SUMMARY OF THE INVENTION

This invention has been achieved in the light of the above-mentioned problems and situation, and it is an object of the invention to provide a disk apparatus in which both the safety factor of a motor and the temporal margin for switching the motor are fully secured in the clamp releasing operation, despite a simple structure in which the shape of a cam groove is changed.

Also, it is another object of the invention to provide a disk apparatus in which the time required for the clamp operation and clamp releasing operation is shortened without decreasing the safety factor of the motor output in the manner of shortening the time required for the down motion of the cam projection when the magnetic force of a clamp mechanism has no influence on the increased load of the motor, and suppressing the load of the motor required for the down motion of the cam projection only when the magnetic force of the clamp mechanism has any influence on the increased load of the motor in the clamp releasing operation.

A disk apparatus of the invention includes a clamp mechanism consisting of a first adsorbent and a second adsorbent that is a partner of the first adsorbent to clamp a disk between the first and second adsorbents by sucking each other due to a magnetic force, and a cam mechanism having a cam body capable of traverse motion with a motor as a drive source, and a lift that is moved vertically by following the traverse motion of the cam body, in which when the lift of the cam mechanism makes a lowering operation, the second adsorbent is pulled down by the lift and separated away from the first adsorbent so that the disk is released from a clamped state by the clamp mechanism.

Also, two inclined faces that are opposed vertically and inclined in the same direction are provided in the cam body, the slope of an upper inclined face of the two inclined faces being smaller than that of a lower inclined face, in which a cam projection provided on the lift and guided by one of the two inclined faces on a traverse motion of the cam body is disposed between the two inclined faces, and the horizontal length of the upper inclined face is decided so that the second adsorbent may descend to a position where a suction force between the first and second adsorbents disappears when the cam projection is lowered to an intermediate position on the upper inclined face.

In the disk apparatus with this constitution, when the magnetic force of the clamp mechanism has any influence on the increased load of the motor, the cam projection slides and descends on the upper inclined face of smaller slope, so that the load of the motor is not excessively increased, making it possible to fully secure the safety factor of the output. And the time for which the cam projection slides and descends on the upper inclined face of smaller slope occurs only when the magnetic force of the clamp mechanism has any influence on the increased load of the motor, and after the magnetic force of the clamp mechanism has no influence on the increased load of the motor, the cam projection transfers to the lower inclined face of larger slope and slides and descends on the lower inclined face, whereby the time since the cam projection transfers to the lower inclined face of larger slope until it arrives at the bottom end is shortened. Accordingly, the total time required for the clamp releasing operation is shortened, and the safety factor of the motor output is fully secured.

Also, when the clamp operation is performed, the cam projection slides up the lower inclined face of larger slope, in which the magnetic force of the clamp mechanism has no influence on the increased load of the motor. Accordingly, the safety factor of the motor output is sully secured, and the time required for the clamp operation is fully shortened.

In this invention, it is desirable that the upper inclined face and the lower inclined face are formed by the upper groove wall face and the lower groove wall face of the cam groove formed in the cam body. Thereby, it is only necessary to change the slope of the upper inclined face or lower inclined face of the cam groove in the cam body employed for the conventional disk apparatus.

This invention provides a disk apparatus including a clamp mechanism consisting of a first adsorbent and a second adsorbent that is a partner of the first adsorbent to clamp a disk between the first and second adsorbents by sucking each other due to a magnetic force, and a cam mechanism having a cam body capable of traverse motion with a motor as a drive source, and a lift that is moved vertically by following the traverse motion of the cam body, in which when the lift of the cam mechanism makes a lowering operation, the second adsorbent is pulled down by the lift and separated away from the first adsorbent so that the disk is released from a clamped state by the clamp mechanism, wherein the second adsorbent is equipped in a frame capable of vertically oscillating around a fulcrum at one end in the fore and aft direction, in which a free end portion formed at the other end of the frame in the fore and aft direction is linked to the lift, so that a lowering operation of the free end portion of the frame is caused to follow the lowering operation of the lift, an upper inclined face and a lower inclined face that are opposed vertically and inclined in the same direction are formed by an upper groove wall face and a lower groove wall face of a cam groove formed in the cam body, the slope of the upper inclined face being smaller than that of the lower inclined face, in which a cam projection provided on the lift and guided by one of the two inclined faces on a traverse motion of the cam body is disposed between the two inclined faces, and the horizontal length of the upper inclined face is decided so that the second adsorbent may descend to a position where a suction force between the first and second adsorbents disappears when the cam projection is lowered to an intermediate position on the upper inclined face. The operation of the invention will be described below in connection with the following embodiments.

### BRIEF DESCRIPTION OF THE DRAWINGS

These and other objects and advantages of this invention will become more fully apparent from the following detailed description taken with the accompanying drawings in which:

FIGS. 1A to 1D are explanatory views for explaining the operation of a cam mechanism employed for a disk apparatus according to the invention, as seen from the front face;

FIGS. 2A to 2C are explanatory views showing the action of the cam mechanism of the disk apparatus according to the invention and the action of the conventional cam mechanism in contrast;

FIG. 3 is a side view, partially broken away, showing the basic constitution of the disk apparatus; and

FIG. 4 is a schematic front view of the cam mechanism employed for the conventional cam mechanism.

### DETAILED DESCRIPTION OF THE PREFERRED EMBODIMENTS

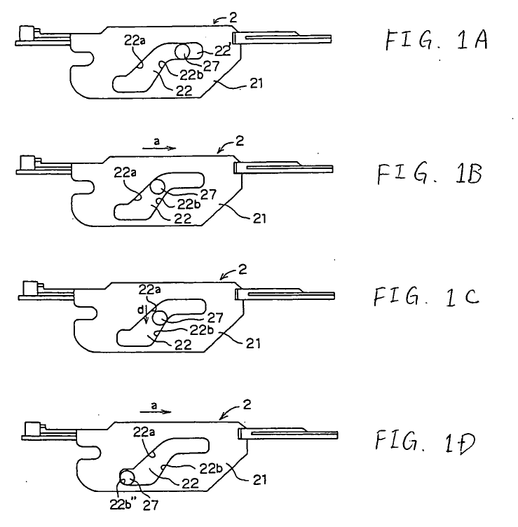

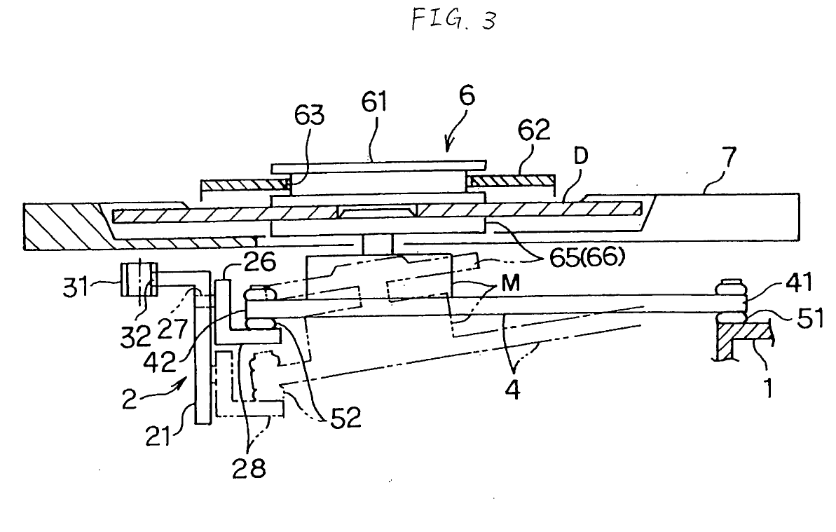

FIGS. 1A to 1D show the operations of a cam mechanism employed for a disk apparatus according to the invention, as seen from the front face. This cam mechanism corresponds to the cam mechanism 2 in the basic constitution of the disk apparatus as shown in FIG. 3. In FIGS. 1A to 1D, reference numeral 21 denotes a cam body, 22 denotes a cam groove, 22a denotes an upper inclined face, 22b denotes a lower inclined face, and 27 denotes a cam projection. The other constitution of the disk apparatus is the same as shown in FIG. 3.

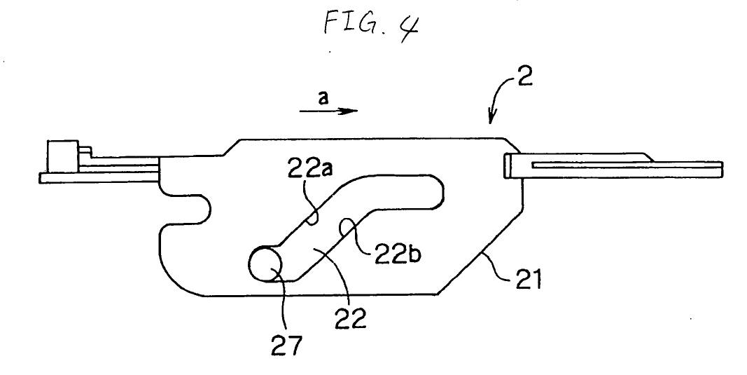

The cam mechanism 2 as shown in FIGS. 1A to 1D are different from the conventional cam mechanism as shown in FIG. 4 in that the upper inclined face 22a and the lower inclined face 22b that are formed by the upper groove wall face and the lower groove wall face of the cam groove 22 and opposed vertically have different slopes, in which the slope of the upper inclined face 22a is smaller than that of the lower inclined face 22b, and a cam projection 27 guided by one of two inclined faces 22a and 22b is disposed between two inclined faces 22a and 22b.

In this cam mechanism 2, when the cam projection 27 is located in an upper horizontal part 22′ as in FIG. 1A, a disk D is kept in a clamped state by a clamp mechanism 6 as shown in FIG. 3.

If the clamp releasing operation is performed from this state, the cam projection 27 slides on the upper inclined face 22a of smaller slope and is pushed down, along with a traverse motion of the cam body 21 as indicated by the arrow A in FIG. 1B, and then, the lift 26 as shown in FIG. 3 moves down to cause a free end portion 42 of the frame 4 to descend, so that the second adsorbent 65 is separated away from the first adsorbent 61 against a magnetic force. And the cam projection 27 is lowered to an intermediate position on the upper inclined face 22a at the position of the second adsorbent 65 when the suction force between the first and second adsorbents 62 and 65 disappears. In other words, when the cam projection 27 is lowered to the intermediate position on the upper inclined face 22a, the second adsorbent descends to the position where the suction force between the first and second adsorbents 62 and 65 disappears. Accordingly, when the suction force between the first and second adsorbents 62 and 65 disappears, the cam projection 27 in the lift 26 transfers to the lower inclined face 22b of larger slope owing to a weight of the second adsorbent 65 or the frame 4 as indicated by the arrow d as in FIG. 1C. Then, along with a traverse motion of the cam body 21, the cam projection 27 transfers to the lower horizontal part 22′ of the cam groove 22 as in FIG. 1D, thereby completing the clamp releasing operation.

On the contrary, in the clamp operation, the cam body 21 performs a traverse motion in the opposite direction of the arrow A from the state FIG. 1D, so that the cam projection 27 is pushed up on the lower inclined face 22b of larger slope and transfers to the upper horizontal part 22′ of the cam groove 22 as in FIG. 1A, thereby completing the clamp operation.

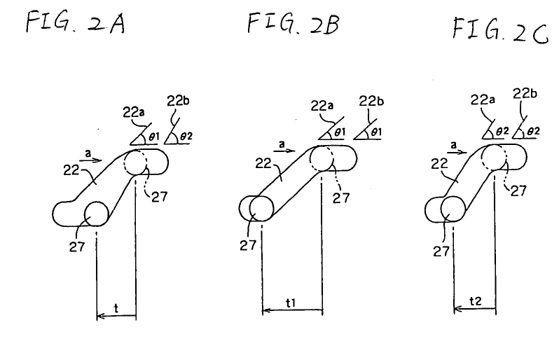

Referring to FIGS. 2A to 2C, the operation of the cam mechanism in the disk apparatus according to this invention and the operation of the conventional cam mechanism will be described below in contrast.

FIG. 2A shows the cam mechanism according to this invention, and FIGS. 2B and 2C show the conventional cam mechanism. In these figures, . 1 and . 2 are inclinations, in which . 1 is smaller than . 2. And in the cam mechanism of the invention as shown in FIG. 2A, the inclination . 1 of the upper inclined face 22a is smaller than inclination . 2 of the lower inclined face 22b. In the cam mechanism as shown in FIG. 2B, both the upper inclined face 22a and the lower inclined faces 22b have smaller inclination . 1. In the cam mechanism as shown in FIG. 2C, both the upper inclined face 22a and the lower inclined faces 22b have larger inclination . 2.

In the cam mechanism as shown in FIG. 2B, if the cam body performs a traverse motion in the direction of the arrow a in the clamp releasing operation, the cam projection 27 is pushed up by the upper inclined face 22a, until the magnetic force of the clamp mechanism loses its influence. Thereafter, though the lowering of the cam projection 27 is guided by the lower inclined face 22b, both the upper inclined face 22a and the lower inclined face 22b have small inclination . 1, whereby the time t1 up to the end of the clamp releasing operation is relatively longer, corresponding to the small inclination . 1 for the upper inclined face 22a and the lower inclined face 22b, and the load of the motor is not too large.

Also, in the cam mechanism as shown in FIG. 2C, if the cam body performs a traverse motion in the direction of the arrow a in the clamp releasing operation, the cam projection 27 is pushed down by the upper inclined face 22a, until the magnetic force of the clamp mechanism loses its influence. Thereafter, though the lowering of the cam projection 27 is guided by the lower inclined face 22b, both the upper inclined face 22a and the lower inclined face 22b have large inclination . 2, whereby the time t2 up to the end of the clamp releasing operation is relatively shorter, corresponding to the large inclination . 2 for the upper inclined face 22a and the lower inclined face 22b, and the load of the motor is increased.

On the contrary, in the cam mechanism of the invention as shown in FIG. 2A, when the magnetic force of the clamp mechanism has any influence on the increased load of the motor, the cam projection slides and descends on the upper inclined face 22a having small inclination . 1. Therefore, the load of the motor is not too large, and the safety factor of the output is fully secured. And the time for which the cam projection slides and descends on the upper inclined face 22a having small inclination . 1 occurs only when the magnetic force of the clamp mechanism has any influence on the increased load of the motor, and after the magnetic force has no influence on the increased load of the motor, the cam projection 27 transfers to the lower inclined face of larger inclination . 2 and slides and descends on the lower inclined face, whereby the time since the cam projection 27 transfers to the lower inclined face 22b of larger inclination . 2 until it arrives at its bottom end is shortened. Accordingly, the time required for the clamp releasing operation is between t1 and t2.

As described above, in the cam mechanism of the invention, in the clamp releasing operation, the load of the motor is suppressed, and the time required for the clamp releasing operation is shortened.

In this way, in the cam mechanism according to this invention, in the clamp releasing operation, the time t1 is relatively long in FIG. 2B, the time t2 is shorter in FIG. 2C, and in FIG. 2A for the cam mechanism of the invention, the time is equal to the time t2 in FIG. 2C, because the lower inclined face 22b is employed. Also, in FIG. 2C and FIG. 2A for the cam mechanism of the invention, the lower inclined face 22b having large inclination . 2 is employed to push up the cam projection 27, whereby the load of the motor is larger than in FIG. 2B where the lower inclined face 22b having small inclination . 1 is employed, but the safety factor is not degraded by the increased load in this case, because the magnetic force of the clamp mechanism has no influence on the load of the motor in the clamp operation.

As described above, with this invention, the upper inclined face and the lower inclined face of the cam groove have different slopes, whereby there is the effect that the safety factor of the motor and the temporal margin for switching the motor in the clamp releasing operation can be fully secured. Also, with this invention, in the clamp releasing operation, the time for the cam projection to perform a down motion is shortened when the magnetic force of the clamp mechanism has no influence on the increased load of the motor, and the load of the motor required for the cam projection to perform a down operation is suppressed, only when the magnetic force of the clamp mechanism has any influence on the increased load of the motor, whereby the time required for the clamp operation and clamp releasing operation is shortened without degrading the safety factor of the motor output. Accordingly, even if the disk apparatus has the motor as the drive source of the cam mechanism that is shared with the feed operation motor for the optical pickup, the time required for the clamp operation or clamp releasing operation is shortened, and the temporal margin for switching the motor operation between the feed operation of the optical pickup and the clamp operation of clamp releasing operation is increased, thereby reducing the risk that the clamp releasing operation is performed while the disk is being rotated due to runaway of the feed operation, or the disk tray starts to be moved before completion of the clamp operation.

What is claimed is:

1. A disk apparatus comprising:
a clamp mechanism including:
a first adsorbent; and
a second adsorbent; and
a cam mechanism including:
a cam body capable of traverse motion with a motor as a drive source; and
a lift that is moved vertically by following the traverse motion of the cam body, wherein:
a disk is clamped between the first and second adsorbents by sucking each other due to a magnetic force;
when the lift of the cam mechanism makes a lowering operation, the second adsorbent is pulled down by the lift and separated away from the first adsorbent so that the disk is released from a clamped state by the clamp mechanism;
the second adsorbent is equipped in a frame capable of vertically oscillating around a fulcrum at one end in the fore and aft direction, in which a free end portion formed at the other end of the frame in the fore and aft direction is linked to the lift, so that a lowering operation of the free end portion of the frame is caused to follow the lowering operation of the lift; and
an upper inclined face and a lower inclined face that are opposed vertically and inclined in the same direction are formed by an upper groove wall face and a lower groove wall face of a cam groove formed in the cam body, the slope of the upper inclined face being smaller than that of the lower inclined face, in which a cam projection provided on the lift and guided by one of the two inclined faces on a traverse motion of the cam body is disposed between the two inclined faces, and the horizontal length of the upper inclined face is decided so that the second adsorbent may descend to a position where a suction force between the first and second adsorbents disappears when the cam projection is lowered to an intermediate position on the upper inclined face.

2. A disk apparatus comprising:
a clamp mechanism including:
a first adsorbent; and
a second adsorbent; and
a cam mechanism including:
a cam body capable of traverse motion with a motor as a drive source; and
a lift that is moved vertically by following the traverse motion of the cam body, wherein
a disk is clamped between the first and second adsorbents by sucking each other due to a magnetic force;
when the lift of the cam mechanism makes a lowering operation, the second adsorbent is pulled down by the lift and separated away from the first adsorbent so that the disk is released from a clamped state by the clamp mechanism; and
two inclined faces that are opposed vertically and inclined in the same direction are provided in the cam body, the slope of an upper inclined face of the two inclined faces being smaller than that of a lower inclined face, in which a cam projection provided on the lift and guided by one of the two inclined faces on a traverse motion of the cam body is disposed between the two inclined faces, and the horizontal length of the upper inclined face is decided so that the second adsorbent may descend to a position where a suction force between the first and second adsorbents disappears when the cam projection is lowered to an intermediate position on the upper inclined face.

3. The disk apparatus according to claim 2, wherein
the upper inclined face and the lower inclined face are formed by an upper groove wall face and a lower groove wall face of a cam groove formed in the cam body.
